(19) United States
(12) Patent Application Publication
(10) Pub. No.: US 2005/0238841 A1
(43) Pub. Date: Oct. 27, 2005

(54) Flange of a splice protection sleeve and ring for a flange of a splice protection sleeve

(76) Inventors: Alberto Rodrigues, Herblay (FR); Thorsten Muller, Menden (DE); Jean-Louis Delatouche, Chateauneuf en Thymerais (FR); Yannick Schreiber, Chartres (FR)

Correspondence Address: Corning Cable Systems, PO Box 489, Hickory, NC, 28603, US

(21) Appl. No.: 10/488,852

(22) PCT Filed: Aug. 30, 2002
(86) PCT No.: PCT/EP02/09668

§ 371 Date: Oct. 8, 2004

(30) Foreign Application Priority Data
Sep. 7, 2001 (FR) 0111585
Sep. 7, 2001 (FR) 0111586

(51) Int. Cl. B32B 3/02

(52) U.S. Cl. 428/66.6

(57) ABSTRACT

A ring for use in a splice protection sleeve flange includes a collar and means for putting the collar around a cable without slipping the collar over the cable. The collar comprises a base body, the inner and outer circumferential lateral faces of which include a male part and a female part, respectively.

### CROSS REFERENCE TO RELATED APPLICATIONS

This application is a United States national application claiming priority to International Application No. PCT/EP02/09668 filed on Aug. 30, 2002, which in turn claims priority to French Patent Application No. 0111585 filed on Sep. 7, 2001, and French Patent Application No. 0111586 filed on Sep. 7, 2001.

### FIELD OF THE INVENTION

The present invention relates to a splice protection sleeve flange, and especially to rings intended especially to be incorporated into a splice protection sleeve flange.

### BACKGROUND OF THE INVENTION

Splice protection sleeves are used especially in the field of telecommunications for the purpose of protecting a cable, especially a power cable or a telephone cable, such as a fibre-optic cable. For this purpose, the splicing point is surrounded by a sleeve normally consisting of a shell terminated at least at one of its ends, and usually at both its ends, by a flange. The flange comprises an elliptical or circular, annular outer part on the inner face of which a seal is placed, the said seal being made of an elastomer material or often of what is called a gel, especially a polyurethane gel. The seal is interposed between a fixed ring and a moveable ring. By bringing the moveable ring closer to the fixed ring, the seal is compressed so as to make it flow and ensure good sealing around the cable. However, this assumes that the inside diameter of the two rings is as far as possible just greater than the diameter of the cable so that the material of the seal does not flow between the cable and the inner face of the rings. Now, it is desirable that the same splice protection sleeve be able to serve to protect cables of different diameter.

The solution normally used for this purpose consists in providing as many rings of different inside diameter as there are different diameters of cables to be protected. In order not to have to provide as large a number of pieces, rings have already been provided which may be cut along pre-established cutting lines so as to give them different diameters, but with the following drawbacks: the cutting work that has to be carried out on site requires the cable diameter to be measured beforehand and this diameter to be transferred to the ring to be cut, and it is necessary to carry out this work for as many cables as the splice protection sleeve contains, something which, when there are several cables of different diameter, may result in errors. Furthermore, the cutting is irreversible. Once a ring has been cut, it can no longer serve for a cable of smaller diameter. Once it has been cut and found not to be suitable, because of a diameter error having been committed, the ring must be scrapped.

The invention helps to overcome these drawbacks with a ring which does not require the cable diameter to be measured beforehand, but simply a test of positioning the ring around the cable because the ring can be used reversibly, that is to say the same ring, after having been used for a large-diameter cable, can again be used for a small-diameter cable so that there are fewer errors and less scrap and so that any error on site can be immediately remedied.

The ring according to the invention comprises means for putting it around a cable without slipping it thereover. According to the invention, the ring comprises a base part, the inner and outer circumferential lateral faces of which include a male part and a female part, respectively.

The said means may consist of the fact that the ring is split along an entire generatrix or by the fact that it consists of at least two ring sectors joined together into a ring by tenons and mortises. In this way, the ring may be placed around the cable on site without having to slip the cable through it and cut the cable.

The ring according to the invention may thus form part of a set of at least two rings, the base bodies of which are of different diameter and in which the male part of one of the rings penetrates the female part of the other ring.

To adapt the ring to a given cable diameter, the plastic rings are snapped out of each other in order to keep the one whose inside diameter is appropriate to the cable to be surrounded.

According to one embodiment for ensuring good sealing provided by the seal, a projecting part going all around stems from one of the transverse faces of the ring.

The subject of the invention is also a flange of a splice protection sleeve, which comprises an annular outer part and at least one ring according to the invention or a set of rings according to the invention, the male or female part of the ring or, when there are more of them, the male or female part of the larger-diameter ring cooperating with a complementary shape provided on the inner face of the outer part of the flange so as to immobilize the ring in order thus to obtain the fixed ring.

According to another embodiment, the subject of the invention is also a flange of a splice protection sleeve, which comprises an annular outer part and at least one ring according to the invention or a set of rings according to the invention, the male part of the larger-diameter ring, when it is turned towards the outside, just coming into contact with the inner face of the outer part of the flange or, when the female part of this ring is turned towards the outside, the outer lateral face of the base body just coming into contact with the inner face of the outer part of the flange. This allows the moveable ring to be obtained.

As explained above, a seal is in contact with a transverse face of the two rings in which this seal is intended to be compressed.

According to another aspect of the present invention, the present invention relates to the flanges intended especially for being used in splice protection sleeves, such as those found in particular in the telecommunications field for the purpose of protecting a cable, such as a power cable or a telephone cable, for example a fibre-optic cable. Federal Republic of Germany Patent Application No. 19958112.6 discloses a splice protection sleeve comprising a shell closed by two flanges. Each flange defines a passage for a cable. A seal is interposed between two annular walls or walls into which the cable is slipped. One of the walls can move along the cable and is displaced by means of a slide so as to compress the seal and make it flow radially inwards in order for it to be properly applied against the cable and thus ensure good sealing. However, tests have shown that one does not thus obtain the sealing that might be expected. The invention remedies this drawback by means of a flange which ensures good sealing.

According to another aspect of the present invention, the subject of the invention is a flange comprising an annular seal housed in an open chamber between a sleeve and two annular transverse walls internal to the sleeve, at least one of which is movable, with the possibility of flowing radially inwards. According to the invention, means are provided which are intended to maintain contact between the sleeve and the seal when the transverse walls are brought closer together.

It has now been understood that, when by bringing the two transverse walls closer together the seal is made to flow, the latter, contrary to what might be expected, does not flow equally in all directions and especially equally in the radially internal and external directions, but quite to the contrary the flow has a solely inwards preferential direction so that a void is created between the sleeve and that part of the seal which ought to be in contact with this sleeve, but which is only facing the latter and at a certain distance therefrom, via which void leaks take place.

The flange according to the invention passes the following sealing test:

The flange is mounted on a cable so as to close an enclosure immersed in water at 25° C. and filled with air at a pressure of at least 500 mbar and, after the two transverse walls have been brought closer together by a distance representing 50% of the dimension of the seal in the direction in which the walls are brought closer together, no air bubbles escape from the enclosure over a period of 48 hours.

According to a first embodiment, the means for maintaining contact are formed by the fact that the seal is adhesively bonded to the sleeve. This embodiment is not preferred because both the flange and the seal have to be changed if the seal is damaged and because it requires fastidious bonding operations that are not easy to perform. It is preferred for the contact-maintaining means to be obtained by conformation, especially obtained directly when moulding the parts.

According to a first embodiment obtained by conformation and with great effectiveness, the means comprise a projecting portion on one of the transverse walls, and preferably on both transverse walls, the said portion projecting into the chamber. Good results have in particular been obtained when the ratio of the largest dimension of the projecting portion in the direction in which the walls are brought closer together to the distance between the projecting portion and the sleeve is greater than 0.5 and preferably greater than 1. The bulge taken up by the seal thus remains in contact with the projecting portion and no leakage line is created.

Another possibility of forming the contact-maintaining means by conformation consists in providing a projecting portion on the sleeve, this portion projecting into the chamber. Just like the first embodiment, this second embodiment is simple and not difficult to mount, the two walls being interchangeable in the first embodiment just as in the second. It is preferable for the projecting portion, when it is on the sleeve, to be off-centre with respect to the middle of the distance between the two walls after they have been brought closer together, so that contact is easier to maintain between the projecting portion and the seal which has taken a bulge.

According to a third embodiment, the means intended to maintain contact between the sleeve and the seal when the transverse walls have been brought closer together include a second seal interposed between one of the walls, preferably the fixed wall, and a stop for the sleeve, the said stop projecting radially inwards. In this way, the required sealing between the sleeve and the outer circumferential portion of the seal is ensured at a point other than that where it flows and where a bulge detrimental to maintaining good sealing is created. Preferably, the said one wall, namely preferably the fixed wall, is provided with a passage and the seal and the second seal are made as one piece passing into the passage. When the gel serving as the seal is poured in, the two seals and the two sealings required are provided at the same time and the fitting procedure is simplified thereby.

### BRIEF DESCRIPTION OF THE DRAWINGS

In the appended drawing, given solely by way of example:

FIG. 1 is a perspective view of a half-ring according to the invention;

FIG. 2 is a sectional view on the plane II-II in FIG. 1;

FIG. 3 is a perspective view of an alternative form of a ring according to the invention;

FIG. 4 is a perspective view illustrating a set of two rings fitted around a cable;

FIG. 5 is a perspective view showing a flange of a splice protection sleeve according to the invention;

FIG. 6 is a partial sectional view corresponding to FIG. 5, the cross section passing through the axis of a cable;

FIG. 7 is a view of an alternative form compared with FIG. 6;

FIG. 8 is a perspective view of a half-flange according to another aspect of the present invention, two half-flanges of this kind being assembled by tenons and mortises into a complete flange;

FIG. 9 is a perspective view of one of the transverse walls of one half of the flange in FIG. 8;

FIG. 10 is a sectional view on the plane X-X in FIG. 9;

FIG. 11 is a sectional view passing through the axis of the flange in a second embodiment;

FIG. 12 is a sectional view passing through the axis of the flange in a third embodiment;

FIG. 13 is a sectional view passing through the axis of the flange in a fourth embodiment; and

FIG. 14 is a sectional view of the sealing test apparatus.

### DETAILED DESCRIPTION OF THE INVENTION

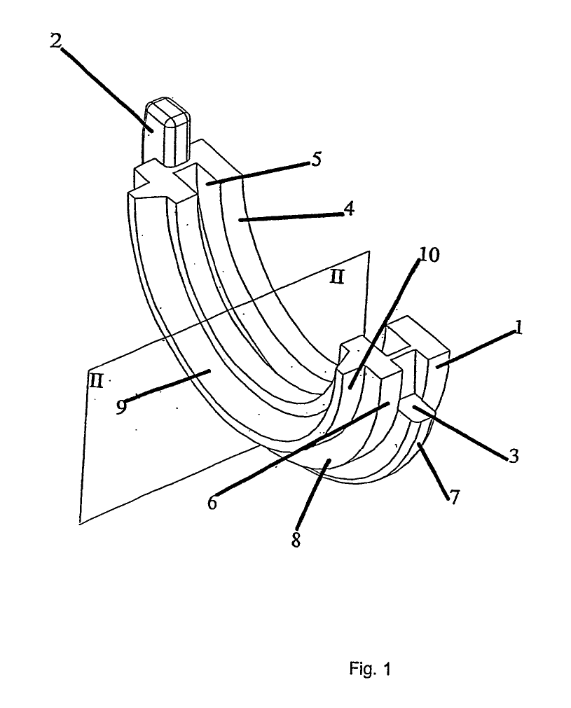

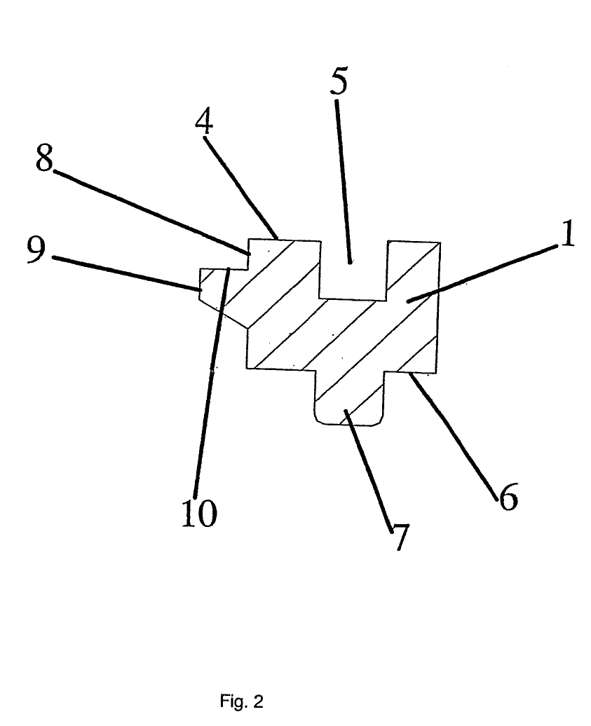

The half-ring shown in FIGS. 1 and 2 comprises a base body 1, tenons 2 and mortises 3 allowing this half-ring to be assembled with another identical half-ring into a complete ring. The inner circumferential lateral face 4 has a groove 5, while the outer circumferential lateral face 6 has a rib 7. These grooves and ribs could have been replaced with cavities and projections, respectively.

FIG. 2 shows that the ring also has on one of its transverse faces 8 a projecting part 9, one of the lateral faces 10 of which is at the mid-height of the transverse face 8.

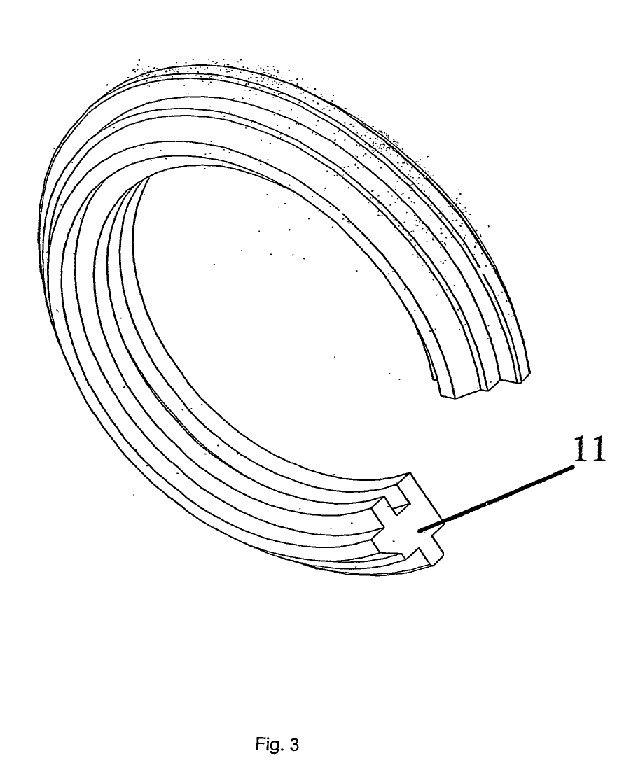

In FIG. 3, the ring consists of a single piece instead of consisting of two half-rings, but it is split along a longitudinal slit 11, which therefore extends along a generatrix. The ring is made of a sufficiently flexible plastic so that, by moving the two facing edges of the ring apart, the ring can be passed around a cable and left to close up, practically filling the space between the slit.

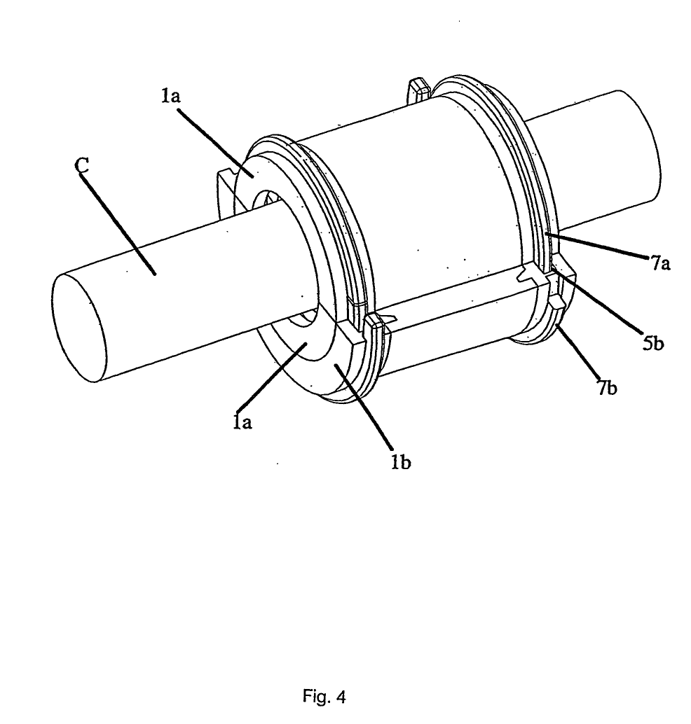

In FIG. 4, a ring 1a has already been placed around a cable C and it will be noticed that the space between the cable C and an inner lateral face of an outer part of the flange has not been filled. A second ring 1b, of larger diameter than the ring 1a, is then put into place, the rings 1a and 1b being assembled via their respective groove 5b and rib 7a. The device may thus be adapted to the diameter of the cable with the subsequent possibility, for a larger-diameter cable, of removing the ring 1a.

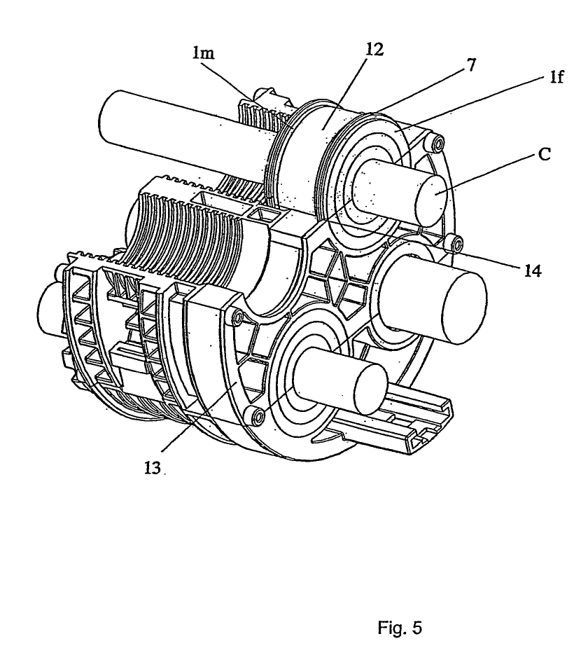

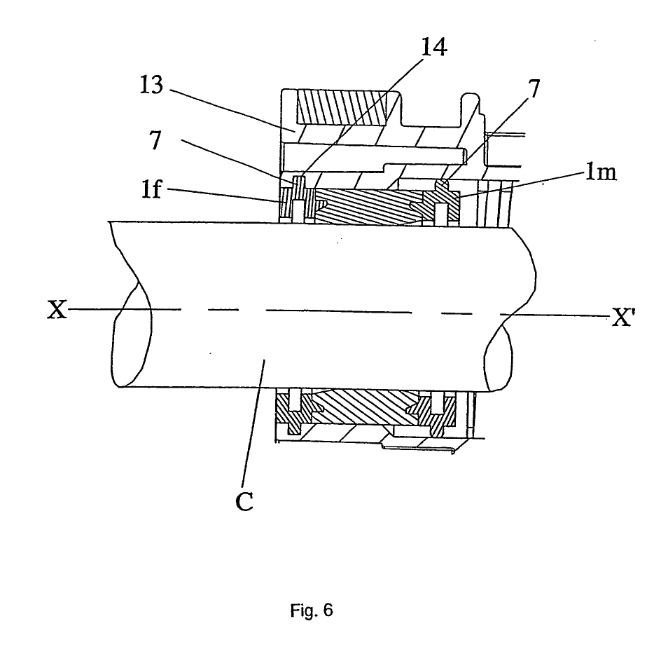

Shown in the perspective view in FIG. 5 is a flange of a splice protection sleeve for the passage of four cables. The cable C is surrounded by a fixed ring 1f and by a moveable ring 1m, between which a seal 12 has been placed. Provided on the inner lateral face of an annular outer part 13 of the flange is a slot 14 into which the rib 7 of the outermost ring of the set 1f of rings penetrates, so that the set 1f is immobilized and serves as a fixed ring. On the other hand, the outermost rib of the set 1m of rings is flush with the inner face of the annular outer part 13, so that, and as may also be seen in FIG. 6, this set 1m of rings can slide along the direction of the axis XX′ of the cable C.

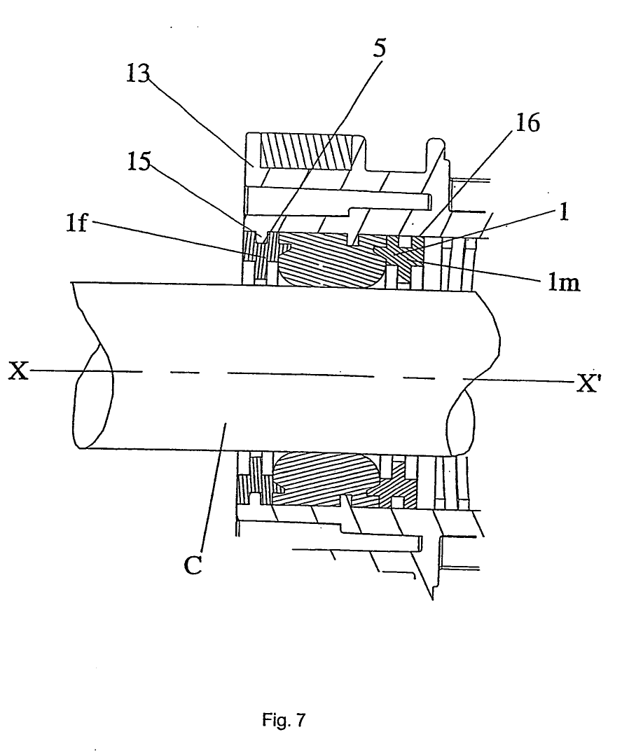

In FIG. 7, it is a rib 15 of the annular outer part 13 of the flange which penetrates the outermost groove of the set 1f in order to immobilize this set, while the outer later face 16 of the base body 1 of the outermost ring of the set 1m just comes into contact with the inner face of the outer part 13 of the flange.

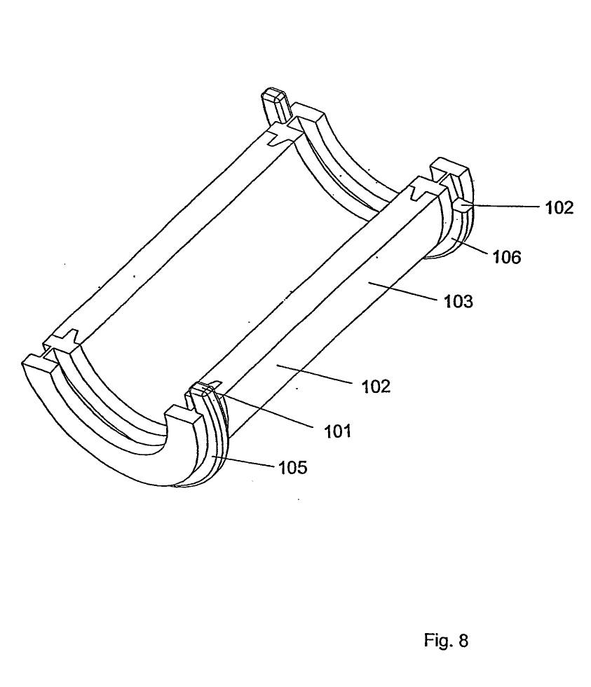

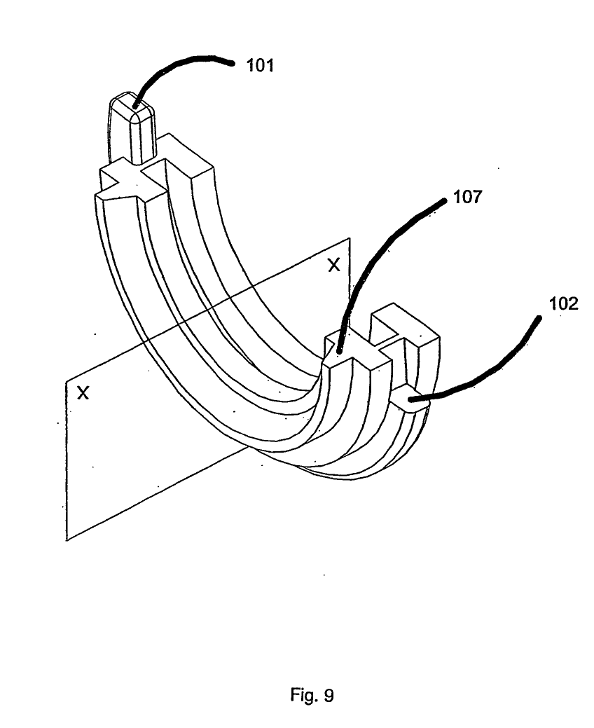

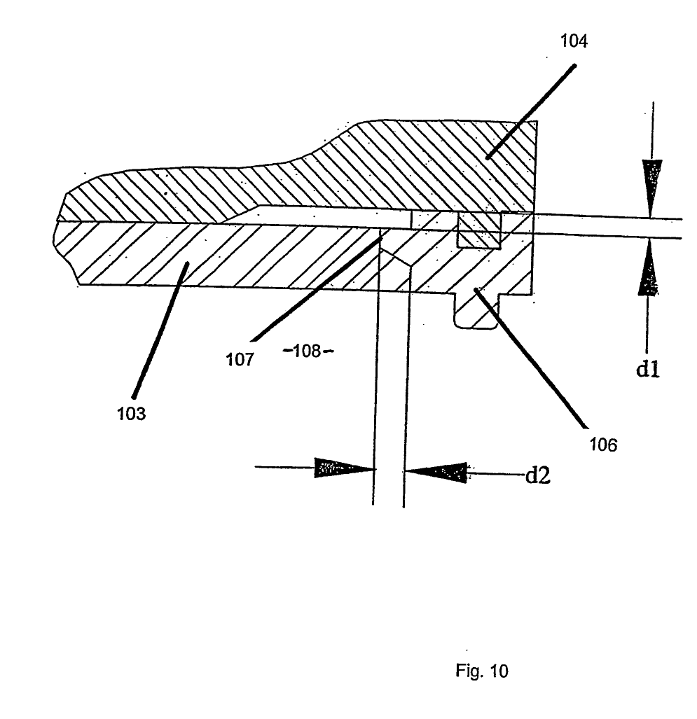

The half-flange shown in FIG. 8 is intended to be assembled by tenons 101 and mortises 102 into an annular flange around a cable. Only shown in FIG. 8 are the seal 103, housed between a sleeve 104 which may be seen in FIG. 10 and the following figures, a transverse fixed wall 105 and a transverse movable wall 106, one half of the wall 105 being shown in detail in FIG. 9. When the movable wall 106 is brought closer to the fixed wall 105, the seal 103 is compressed and it flows radially inwards.

As shown in FIG. 10, the movable wall 106 has a projecting portion 107 which projects into the chamber 108 over a distance, measured in the direction in which the walls 105 and 106 are brought closer together, of d2. The distance between the projecting portion 107 and the sleeve 104 is denoted by d1. The d2/d1 ratio is equal to 2.

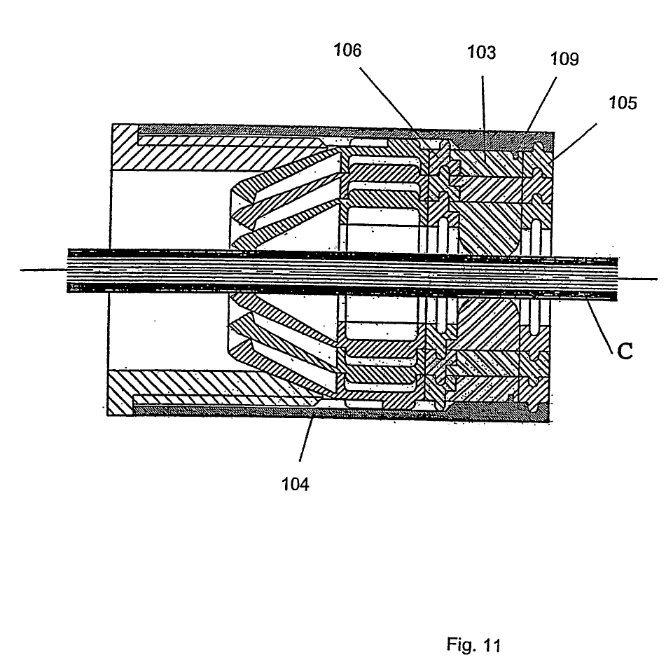

In FIG. 11, the sleeve 104 has a projection 109, which projects radially inwards and is not at the same distance from the two walls 105 and 106 when the latter are brought closer together. The projection has a sufficient radial dimension so that, when taking its position into account, it is still in contact with the seal 103 when the latter, after having been compressed by the two walls 105, 106 having been brought closer together, has taken a bulge.

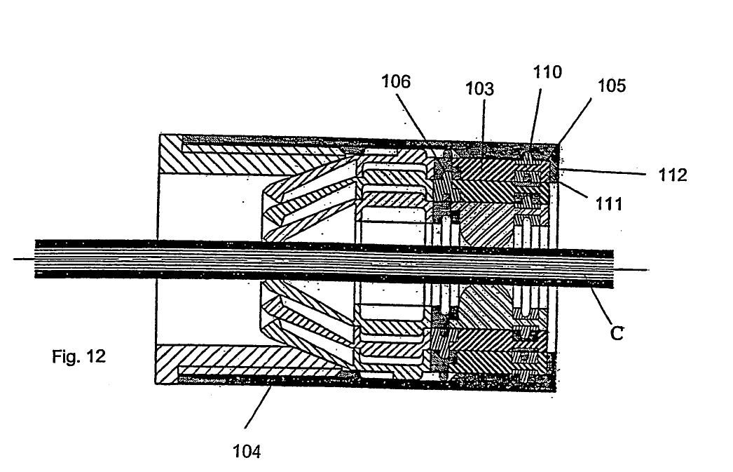

In FIG. 12, the seal 103 passes through a passage 110 made in the fixed wall 105 and is extended radially inwards on the other side of the latter by a portion 111 which is interposed between the outer face of the wall 105 and a stop 112 which projects radially inwards from the sleeve 104.

When the two walls 105 and 106 are brought closer together, the portion 111 of the seal which forms a second seal ensures good contact with the sleeve since this contact takes place on the radial stop 112 and since the portion 111 of the seal does not take a bulge at this point, when the two walls 105 and 106 are brought closer together.

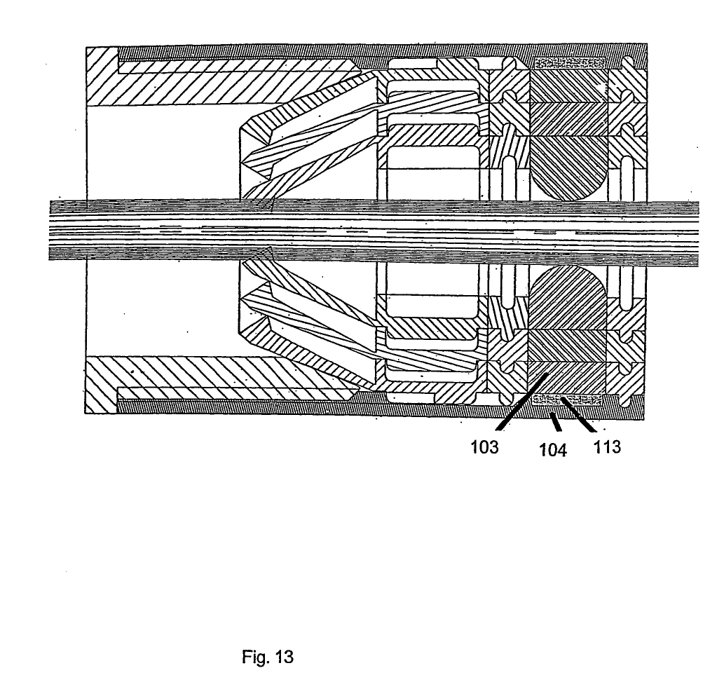

In FIG. 13, the seal 103 is adhesively bonded to the sleeve 104 by a layer of adhesive 113.

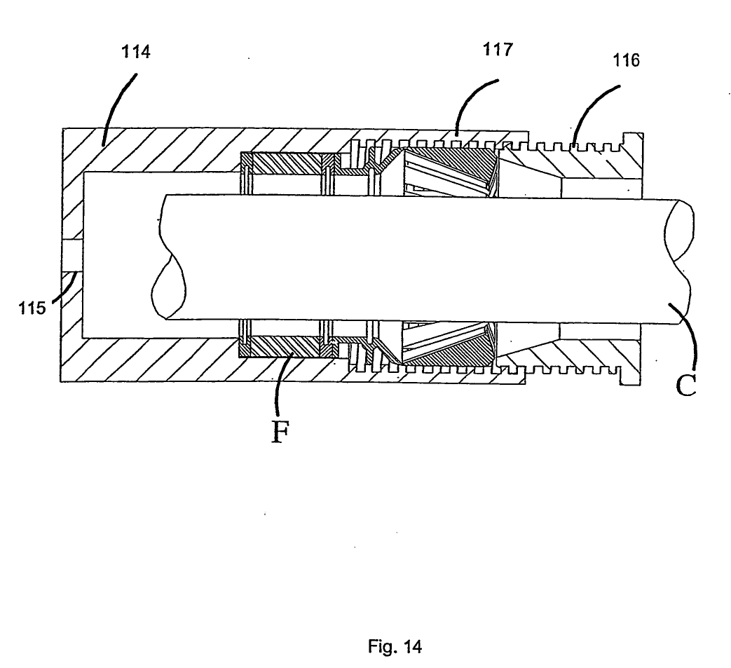

The apparatus in FIG. 14 comprises a chamber 114 defining, with a flange F to be tested and placed around the cable C, an enclosure in which a vacuum of 500 mbar may be created by a pump fitted onto an inlet fitting 115. The chamber 114 is immersed in a water bath at 25° C. The walls of a flange F may be brought closer together by 50% by a screw 116/nut 117 system.

1. Ring comprising means for putting it around a cable without slipping it thereover, wherein the ring comprises a base body, the inner and outer circumferential lateral faces of which include a male part and a female part, respectively.

2. Ring according to claim 1, wherein a projecting part going all around stems from one of the transverse faces.

3. Ring according to claim 1, wherein the said means comprises a ring that is split along an entire generatrix.

4. Ring according to claim 1, wherein the said means comprises a ring having at least two ring sectors joined together into a collar by tenons and mortises.

5. Ring according to claim 1, wherein the base body is made of plastic.

6. Ring according to claim 1 comprising a set of at least two rings wherein the base bodies are of different diameter and wherein the male part of one of the rings penetrates the female part of the other ring.

7. Flange of a splice protection sleeve, which comprises an annular outer part, for cooperating with at least one ring according to claim 1, the male or female part of the ring cooperating with a complementary shape provided on the inner face of the outer part of the flange.

8. Flange of a splice protection sleeve, which comprises an annular outer part, adapted to receive thereon at least one ring according to claim 1, the male part of the ring, when it is turned towards the outside, just coming into contact with the inner face of the outer part of the flange or, when the female part of the ring is turned towards the outside, the outer lateral face of the base body just coming into contact with the inner face of the outer part of the flange.

9. Flange according to claim 7, further comprising a seal in contact with a transverse face of the ring.

10. Flange comprising an annular seal housed in an open chamber between a sleeve and two annular transverse walls internal to the sleeve, at least one of which is movable, the seal flowing radially inwards when the transverse walls are brought closer together, the flange comprising means for maintaining contact between the sleeve and the seal when the transverse walls are brought closer together.

11. Flange according to claim 10, further comprising means for passing the following sealing test: the flange is mounted on a cable so as to close an enclosure immersed in water at 25° C. and filled with air at a pressure of at least 500 mbar and, after the two walls have been brought closer together by a distance representing 50% of the dimension of the seal in the direction in which the walls are brought closer together, no air bubbles escape from the enclosure over a period of 48 hours.

12. Flange according to claim 10, wherein the means for maintaining contact comprise a projecting portion on one of the transverse walls, the said portion projecting into the chamber.

13. Flange according to claim 12, wherein the ratio of the largest dimension (d2) of the projecting portion in the direction in which the walls are brought closer together to the distance (d1) between the projecting portion and the sleeve is greater than 0.5.

14. Flange according to claim 12, wherein the projecting portion is on the movable wall.

15. Flange according to claim 12, wherein a projecting portion is on each wall.

16. Flange according to claim 10, wherein the means for maintaining contact include a projecting portion on the sleeve, projecting into the chamber.

17. Flange according to claim 16, wherein the projecting portion is in a position off-centre with respect to the middle of the distance between the two walls after they have been brought closer together.

18. Flange according to claim 10, wherein the means for maintaining contact include a second seal interposed between one of the walls and a stop for the sleeve, the said stop projecting radially inwards.

19. Flange according to claim 18, wherein the said one wall is provided with a passage and wherein the seal and the second seal are made as one piece passing into the passage.

20. Flange according to claim 10, wherein the seal is adhesively bonded to the sleeve.
